(19) United States
(12) Patent Application Publication
(10) Pub. No.: US 2026/0356188 A1
(43) Pub. Date: Nov. 12, 2026

(54) Pre-Integrated Oil Cooling Module and Vehicle

(71) Applicant: Robert Bosch GmbH, Stuttgart (DE)

(72) Inventors: Denis Neher, Remchingen (DE); Thomas Holzer, Karlsbad (DE); Dana Nicgorski, Burlington, MA (US)

(21) Appl. No.: 19/129,929

(22) PCT Filed: Nov. 9, 2023
(86) PCT No.: PCT/EP2023/081252

§ 371 Date: May 14, 2025

(30) Foreign Application Priority Data
Nov. 14, 2022 (DE) 10 2022 212 045.0

(51) Int. Cl. B60K 11/02; B60H 1/00; B60K 1/00

(52) U.S. Cl. CPC B60K 11/02; B60H 1/00278; B60H 2001/00307; B60K 2001/005; B60K 2001/006

(57) ABSTRACT

A pre-integrated oil cooling module at least for a drive-cooling system for cooling a drive unit, in particular an electric drive unit (EDU), using oil as the heat transfer medium for an in particular battery-and/or fuel-cell-operated vehicle, includes at least one drive-cooling component, which is designed as an oil pump at least for recirculation of the heat transfer medium and/or as an oil heat exchanger for dissipating heat absorbed by the drive unit via the heat transfer medium, and at least one further drive-cooling component of the drive-cooling system and/or at least one battery temperature control component of a battery temperature control system of the vehicle and/or at least one passenger compartment temperature control component of a passenger compartment temperature control system of the vehicle.

### PRIOR ART

Drive systems of vehicles, in particular of electrically operated vehicles, generate heat that needs to be dissipated. This is usually done with cooling circuits consisting of a plurality of individual components.

### DISCLOSURE OF THE INVENTION

The invention relates to a pre-integrated oil cooling module at least for a drive-cooling system for cooling a drive unit, in particular an electric drive unit (EDU), using oil as the heat transfer medium for an in particular battery-and/or fuel-cell-operated vehicle, comprising at least one drive-cooling component, which is designed as an oil pump at least for recirculation of the heat transfer medium and/or as an oil heat exchanger for dissipating heat absorbed by the drive unit via the heat transfer medium, and comprising at least one further drive-cooling component of the drive-cooling system and/or at least one battery temperature control component of a battery temperature control system of the vehicle and/or at least one passenger compartment temperature control component of a passenger compartment temperature control system of the vehicle.

The design according to the invention of the pre-integrated oil cooling module advantageously reduces complexity, since only the pre-integrated oil cooling module has to be installed in the vehicle instead of many individual components. Advantageously, power and efficiency can be increased, because the individual components of the pre-integrated oil cooling module can be optimally matched to one another through the module design. Advantageously, design space can be reduced, since the module design in particular allows for an optimum arrangement within a smaller design space.

Preferably, the pre-integrated oil cooling module is provided for a vehicle, in particular an electric vehicle. Preferably, the vehicle is designed as a battery-and/or fuel-cell-operated vehicle. Alternatively, the vehicle could also be configured with an internal combustion engine and/or an engine that seems appropriate to a person skilled in the art. For example, the vehicle is designed as a passenger car, a commercial vehicle, a rail vehicle, a ship, and/or an aircraft, or as a drone. It is conceivable that the pre-integrated oil cooling module may be designed to be usable in a stationary machine, such as a machine tool. In particular, the pre-integrated oil cooling module could be retrofittable in a vehicle and/or stationary machine. In particular, the pre-integrated oil cooling module is designed as a replacement part. In particular, the pre-integrated oil cooling module is designed in different embodiments, in particular with a different number of components. In particular, the various embodiments of the pre-integrated oil cooling module are interchangeable with one another and/or expandable.

In particular, a “pre-integrated module” is intended to be understood as a pre-assembly that can be installed by simply screwing on and/or plugging in (plug and play), in particular without prior assembly and/or calibration of the individual components of the pre-assembly, preferably by an assembly worker without specific expertise. In particular, a “module” is intended to be understood as an assembly comprising various components that are permanently connected to one other and/or integrated into one another and/or at least permanently mounted on a carrier element. In particular, an “oil cooling module” is intended to be understood as an assembly that assumes a cooling function, wherein the liquid transfer medium is configured as oil. In particular, the oil is provided to absorb and remove heat from the component to be cooled, in particular a drive system. In particular, the pre-integrated oil cooling module forms a single, pre-assembled component that preferably allows all components included in the oil cooling module to be installed in the vehicle in a common assembly step. In particular, the oil cooling module is deliverable in one piece to an assembly line for vehicles. However, it is also conceivable that the oil cooling module may be at least partially expandable or separable. In particular, the oil cooling module has defined interfaces, which are provided for assembly with matching counterparts and/or matching receptacles of the respective vehicle. In particular, the oil cooling module is provided for plug-and-play installation.

Preferably, the drive-cooling system is configured to cool at least one drive unit. Preferably, the drive-cooling system comprises at least one oil cooling mechanism. Preferably, the heat transfer medium, in particular a liquid transfer medium, is configured as an oil, in particular a mineral oil. Alternatively, it is conceivable that the liquid transfer medium is configured as a, in particular water and/or glycol-based, coolant that includes various additives, such as freeze protection and/or corrosion protection. Preferably, the oil is provided to absorb heat from the drive unit. Preferably, the oil heat exchanger is configured to transfer the heat from the oil to the coolant. Preferably, the transfer of heat from the oil to the coolant is free of a material exchange between the oil and the coolant. Preferably, the oil and the coolant are mechanically separated from each other at least in the oil heat exchanger. Preferably, the heat transfer between the oil and the coolant takes place along a temperature gradient. Alternatively, the oil heat exchanger could also be designed as a radiator, which is configured to radiate heat into an environment, in particular to a gas.

In particular, the “drive unit” comprises at least one component, preferably all components provided for drive system of the vehicle, such as one or more motors, in particular electric motors and/or generators, a transmission, power electronics, or the like. For example, the drive unit may be designed as an electric drive module that combines power electronics and electric motors. The terms “provided” and/or “designed” and/or “configured” are to be understood in particular as specially programmed, designed and/or equipped. The fact that an object is intended for a specific function should be understood in particular to mean that the object fulfills and/or executes this specific function in at least one application and/or operating state.

Preferably, the battery temperature control system is configured to control the temperature of, preferably to cool, and/or heat at least one drive battery and/or one or more other batteries. Preferably, the battery is designed as an energy storage unit for a drive system of the vehicle. Alternatively, the battery could also be designed as a battery that is different from the energy storage unit for the drive system or another battery. Preferably, the battery is configured as a rechargeable battery, in particular a lithium-ion battery or a lead acid battery or a solid battery or a comparable battery.

Preferably, the passenger compartment temperature control system is configured to control the temperature of, preferably to cool, and/or heat a passenger compartment. In particular, cooling and/or heating of the passenger compartment occurs via controlling the temperature of a coolant of the passenger compartment temperature control system. Preferably, the coolant from the drive-cooling circuit of the drive-cooling system and the coolant of the battery temperature control system and the coolant of the passenger compartment temperature control system are designed as the same and/or identical and/or interchangeable coolant and have in particular the same chemical composition.

Preferably, the oil cooling module is modular in structure and may comprise different embodiments. Preferably, the pre-integrated oil cooling module comprises at least one drive-cooling component which, as a basis, is integrated in each embodiment of the oil cooling module. In particular, in at least one embodiment, at least one further drive component may also be integrated into the pre-integrated oil cooling module. In particular, the pre-integrated oil cooling module comprises an integration of at least the further drive-cooling component of the drive-cooling system and at least the battery temperature control component of the battery temperature control system. In particular, the pre-integrated oil cooling module comprises an integration of at least the further drive-cooling component of the drive-cooling system and at least the passenger compartment temperature control component of a passenger compartment temperature control system. More particularly, the pre-integrated oil cooling module comprises an integration of at least the passenger compartment temperature control component of a passenger compartment temperature control system and at least the battery temperature control component of the battery temperature control system. It is conceivable that the pre-integrated oil cooling module may comprise one and/or a plurality of further cooling systems and/or temperature control systems integrated into the pre-integrated oil cooling module. In particular, the pre-integrated oil cooling module could comprise a plurality of possible combinations of each component of the drive-cooling system and battery temperature control system and the passenger compartment temperature control system and any further cooling and/or temperature control system.

Furthermore, it is proposed that the oil cooling module comprises at least three or more drive-cooling components of the drive-cooling system and/or at least two or more battery temperature control components of the battery temperature control system of the vehicle and/or at least two or more passenger compartment temperature control components of the passenger compartment temperature control system of the vehicle. Advantageously, complexity can be reduced as the pre-integrated oil cooling module in particular comprises a greater number of components. Advantageously, a function may be improved because, in particular, the components of the pre-integrated oil cooling module are better matched to one another and a greater number of components of the pre-integrated oil cooling module thus results in an optimized function.

Furthermore, it is proposed that the further drive-cooling component is designed as a coolant pump of the drive-cooling system different from the oil pump, a coolant tank, a coolant radiator, or a bypass valve to selectively turn on and off the coolant radiator. Advantageously, a user-specific pre-integrated oil cooling module may be provided, as in particular the number and/or the component(s) of the drive-cooling system may be assembled in any manner, in particular depending upon the individual needs of a user. Advantageously, efficiency can be improved, since, in particular, heat from the drive system can be harnessed by shutting down the coolant radiator. Preferably, the, in particular electrical, coolant pump of the drive-cooling system is configured for recirculation of a coolant in the drive-cooling circuit, in particular for cooling the drive. Preferably, the coolant pump of the drive-cooling system is configured to provide a pressure, in particular a coolant pressure, for recirculation of the coolant in the drive-cooling circuit. Preferably, the coolant tank, in particular designed as a coolant buffer, is configured to receive excess coolant, in particular temporarily, and/or to provide additional coolant in the event of a coolant shortage. It is conceivable that the coolant tank, in particular a reservoir tank, can be used for a plurality of cooling circuits. In particular, the coolant tank comprises at least one, preferably two, preferably the same number of chambers as cooling circuits. Preferably, the coolant tank is connected to the drive-cooling circuit in series. However, a parallel circuit from the coolant tank with the drive-cooling circuit is conceivable. Preferably, the coolant radiator is designed as a cooler and/or heat exchanger. Preferably, the coolant radiator is configured to deliver heat from the coolant, at least substantially, into ambient air, in particular at least substantially by means of thermal radiation and/or heat convection. It is conceivable that the heat will be dissipated into a liquid and/or a solid material, for example a housing or the like. It is conceivable that the coolant radiator may be configured, in addition to or alternatively to cooling the coolant of the battery temperature control system and/or the passenger compartment temperature control system. Preferably, the bypass valve is provided to switch on and/or switch off the coolant radiator, in particular the drive-cooling system. In particular, the coolant radiator is switched on at least in one operating state via the bypass valve when heat, in particular for cooling, must be dissipated from the coolant. Preferably, the bypass valve is configured to switch off the coolant radiator when the heat from the drive system is usable. Preferably, the bypass valve is electronically controllable. It is conceivable that the bypass valve is configured to connect the coolant radiator, in particular in parallel, to the drive-cooling system or battery temperature control system or the passenger compartment temperature control system. In particular, a “coolant” should be understood to mean water and/or glycol and/or a further liquid transfer medium mixed with different additives, for example freeze protection, corrosion protection or the like. In particular, the liquid transfer medium, for example the water or the glycol, could be designed as a pure material, in particular without additives. It is conceivable that the coolant is designed as a cooling oil. In particular, “heat” is to be understood as thermal energy, which is a temperature difference to a comparison temperature, for example an ambient temperature and/or a coolant temperature and/or housing temperature or the like.

Furthermore, it is proposed that the battery temperature control components are designed as a coolant heat exchanger for dissipating heat generated by a drive battery of the vehicle, as a coolant pump of the battery temperature control system, or as a drive battery heating element. Advantageously, battery temperature control may be optimized because, in particular, the battery temperature control components in the pre-integrated oil cooling module may be optimally matched to one another. Preferably, the battery of the battery temperature control system is configured as a drive battery and/or another battery, for example a battery for supplying electrical power to energy-intensive loads, such as an auxiliary heater and/or multimedia system. Preferably, the coolant heat exchanger is configured to deliver heat from the coolant, at least substantially, into ambient air, in particular at least substantially by means of heat convection. It is conceivable that the heat will be dissipated into a liquid, for example a cooling agent and/or coolant, and/or a solid material, for example a housing or the like. Preferably, the, in particular electrical, coolant pump of the battery temperature control system is configured for recirculation of a coolant in a battery temperature control circuit of the battery temperature control system, in particular to cool a drive battery and/or another battery. Preferably, the coolant pump of the battery temperature control system is configured to provide a pressure, in particular a coolant pressure, for the recirculation of the coolant in the battery temperature control circuit. Preferably, the coolant pump of the battery temperature control system is at least substantially identical to the coolant pump of the drive-cooling system. Preferably, the drive battery heating element is provided for heating the drive battery and/or a further battery in at least one operating state, in particular upon starting. Preferably, the drive battery heating element is designed as a positive temperature coefficient (PTC) heating element. The PTC heating element is designed to control the temperature of gas mixtures, liquids or solids, in particular in a self-regulating manner in a confined space. It is conceivable that the drive battery heating element may be designed as a heating rod and/or heating wire and/or as another heating element that may seem useful to a person skilled in the art. Preferably, the drive battery heating element is configured to provide, in particular electrical, pre-conditioning of the battery in cold ambient conditions, in particular via the power grid from the vehicle.

Additionally, it is proposed that the passenger compartment temperature control components are designed as a passenger compartment heating element or as a coolant pump of the passenger compartment temperature control system. Advantageously, comfort can be increased, because in particular the passenger compartment temperature control components are better coordinated with each other and the passenger compartment temperature control is thereby optimized. Preferably, the passenger compartment heating element is provided for heating the passenger compartment in at least one operating state. Preferably, the passenger compartment heating element is designed as a positive temperature coefficient (PTC) heating element. The PTC heating element is designed to control the temperature of gas mixtures, liquids or solids, in particular in a self-regulating manner in a confined space. It is conceivable that the passenger compartment heating element may be designed as a heating rod and/or heating wire and/or as another heating element that may seem useful to a person skilled in the art. Preferably, the passenger compartment heating element of the passenger compartment temperature control system is at least substantially identical to the drive battery heating element of the battery temperature control system. Preferably, the, in particular electrical, coolant pump of the passenger compartment temperature control system is configured to recirculate a coolant in a passenger compartment temperature control circuit of the passenger compartment temperature control system, in particular for cooling the passenger compartment. Preferably, the coolant pump of the passenger compartment temperature control system is configured to provide a pressure, in particular coolant pressure, for recirculation of the coolant in a passenger compartment temperature control circuit. Preferably, the coolant pump of the passenger compartment temperature control circuit is at least substantially identical to the coolant pump of the drive-cooling system and/or the coolant pump of the battery temperature control system.

In addition, it is proposed that the oil cooling module comprises at least one cooling circuit component of a separate cooling circuit, for example a cooling agent expansion valve of the separate cooling circuit. Advantageously, a function may be improved, as in particular the coolant may be cooled to a temperature below an ambient temperature. Advantageously, energy consumption can be reduced, since in particular the cooling circuit can only be switched on when necessary.

Preferably, the coolant expansion valve is configured to set a coolant temperature, in particular to a temperature below the ambient temperature. Preferably, the coolant expansion valve is configured to regulate cooling performance of the coolant heat exchanger of the battery temperature control system. Preferably, the coolant heat exchanger of the battery temperature control system is connected to the separate cooling circuit.

Furthermore, it is proposed that the oil cooling module comprises at least one connecting valve for selectively connecting or disconnecting at least two coolant circuits of the drive-cooling system, the battery temperature control system, and/or the passenger compartment temperature control system. Advantageously, energy consumption can be reduced, because in particular the cooling circuits can be separated from and/or connected to each other and thereby heat and/or cold can be used for temperature control of at least a drive system and/or a drive battery and/or a passenger compartment. Preferably, the at least one connecting valve is deigned to be electrically controllable. It is conceivable that the, in particular electrical, connecting valve may be designed as a 3-way valve and/or a 5-way valve and/or a multi-path valve that seems useful to a person skilled in the art. Preferably, the drive cooling system and/or the battery temperature control system and/or the passenger compartment temperature control system are connected in parallel in a series circuit via the at least one connecting valve in at least one operating state.

Additionally, it is proposed that the oil cooling module comprises a manifold including at least one conduit of a drive-cooling circuit, at least one conduit of a battery temperature control circuit, and/or at least one conduit of a passenger compartment temperature control circuit. Advantageously, complexity can be reduced as, in particular, all conduits are integrated into the manifold. Advantageously, costs can be reduced because in particular, both the packaging and the assembly/system integration costs for system integration into the vehicle are reduced. Preferably, the at least one conduit in the manifold is designed as a channel. Preferably, the manifold comprises at least one connection designed to connect the drive to be cooled and/or the battery to be temperature controlled and/or the passenger compartment to be temperature controlled, in particular fluidly, to the manifold. In particular, a housing is formed from the pre-integrated oil cooling module at least partially from the manifold.

Additionally, it is proposed that the oil cooling module comprises at least one, particularly integrated, sensor, which is particularly configured to sense at least one temperature and/or a pressure of one of the drive-cooling components, one of the battery temperature control components, one of the passenger compartment temperature control components, and/or within a conduit of a cooling circuit. Advantageously, power may be increased and power consumption reduced, in particular because the sensor allows for precise control and/or regulation from the pre-integrated oil cooling module. Preferably, the sensor is configured to sense a pressure and/or a temperature and/or a flow rate and/or a moisture and/or a glycol content or another parameter that is useful to a person skilled in the art. In particular, the drive-cooling system and the battery temperature control system and the passenger compartment temperature control system each comprise at least one sensor.

Furthermore, it is proposed that that the oil cooling module comprises a central power and/or data transfer interface, which is particularly designed to supply electrical power and/or a data link to at least one module-integrated drive-cooling component, at least one module-integrated battery temperature control component, at least one module-integrated passenger compartment temperature control component, at least one module-integrated connecting valve to selectively connect or disconnect at least two coolant circuits and/or at least one module-integrated sensor. Advantageously, complexity may be reduced as the modular design of the pre-integrated oil cooling module with a central power and/or data transfer interface, for example, reduces the number of wiring harnesses. Preferably, the pre-integrated oil cooling module comprises at least one common wiring harness. In particular, the pre-integrated oil cooling module has a common circuit board. Preferably, the pre-integrated oil cooling module has a common control and/or regulating unit. Preferably, the power and/or data transfer interface is configured to connect to a controller of the vehicle and/or a power supply via the battery and/or the controller of the vehicle. Preferably, the central power and/or data transfer interface is configured as a BUS connection and/or a USB connection and/or a LAN connection. It is conceivable that the data transfer interface may be configured as a wireless data transfer interface, such as a W-LAN connection or a Bluetooth connection or a comparable connection.

Furthermore, a vehicle, in particular a battery-and/or fuel-cell-operated vehicle, is proposed with a pre-integrated oil cooling module. Advantageously, complexity may be reduced, in particular as the number of parts is reduced with the pre-assembled oil cooling module. Advantageously, a function may be improved because, in particular, by the arrangement/integration of the components in the pre-integrated oil cooling module, a function, such as cooling performance, may be improved. Advantageously, power consumption and thereby CO₂ emissions from the vehicle may be reduced as the modular design of the pre-integrated oil cooling module may optimize function and thereby conserve energy.

The pre-integrated oil cooling module according to the invention and the vehicle according to the invention are not intended to be limited to the application and embodiment described above. In particular, the pre-integrated oil cooling module according to the invention and the method according to the invention can have a number of individual elements, components and units as well as method steps that differs from a number mentioned herein in order to fulfill a functionality described herein. Additionally, regarding the ranges of values indicated in this disclosure, values lying within the limits specified hereinabove are also provided to be considered as disclosed and usable as desired.

### DRAWINGS

Further advantages follow from the description of the drawings below. An exemplary embodiment of the invention is shown in the drawing. The drawing, the description, and the claims contain numerous features in combination. A person skilled in the art will appropriately also consider the features individually and combine them into additional advantageous combinations.

The figures show:

FIG. 1 a vehicle having a pre-integrated oil cooling module according to the present invention,

FIG. 2 a summary table with combinations of options for a combination of various embodiments of the pre-integrated oil cooling module and

FIG. 3 a schematic/block diagram of an exemplary embodiment of the pre-integrated oil cooling module.

### DESCRIPTION OF THE EXEMPLARY EMBODIMENT

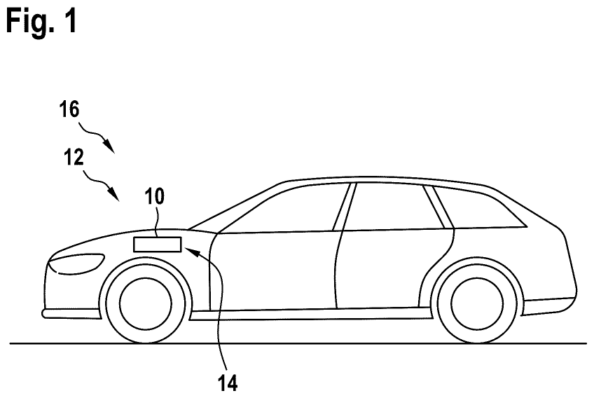

FIG. 1 shows a vehicle 16. The vehicle 16 is designed as a battery-and/or fuel-cell-operated vehicle 16. The vehicle 16 comprises a drive unit 14. The drive unit 14 is configured as an electric drive unit (EDU). The vehicle 16 comprises a pre-integrated oil cooling module 10. The pre-integrated oil cooling module 10 is configured for a drive-cooling system 12. The drive-cooling system 12 is configured to cool the drive unit 14. Cooling of the drive unit 14 of the battery-and/or fuel-cell-operated vehicle 16 is accomplished using oil as the heat transfer medium. Alternatively, the cooling of the vehicle 16 could occur with cooling water or a comparable fluid as a heat transfer medium.

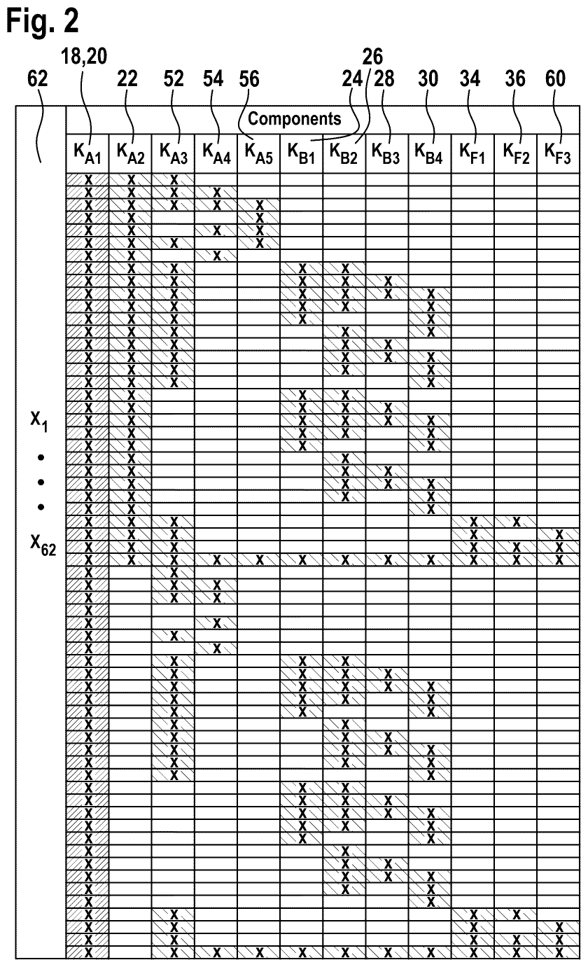

The table in FIG. 2 shows possible embodiments 62 of the pre-integrated oil cooling module 10. The pre-integrated oil cooling module 10 comprises at least one drive-cooling component 18, 20. The drive-cooling component 18 may be designed as an oil pump. The oil pump is configured for recirculation of the heat transfer medium. The oil pump provides a volume of coolant flow. The drive-cooling component 20 may be configured as an oil heat exchanger. The oil heat exchanger is configured to dissipate heat absorbed by the heat transfer medium from the drive unit 14. It is also conceivable that the oil cooling module 10 may comprise the two drive-cooling components 18, 20, an oil pump and oil heat exchanger. The drive-cooling components 18, 20 are part of the drive-cooling system 12. The drive-cooling components 18, 20 are configured to cool the drive unit 14. It is conceivable that the pre-integrated oil cooling module 10 may include only the one and/or the two drive-cooling components 18, 20. The pre-integrated oil cooling module 10 could additionally include further drive-cooling components 22, 52, 54, 56 of the drive-cooling system 12. The pre-integrated oil cooling module 10 could additionally include further battery temperature control components 24, 26, 28, 30 of a battery temperature control system 32 of the vehicle 16. The pre-integrated oil cooling module 10 could additionally include further passenger compartment temperature control components 34, 36 of a passenger compartment temperature control system 38 of the vehicle 16.

The pre-integrated oil cooling module 10 is built in a modular manner. The pre-integrated oil cooling module 10 is modular in design. The pre-integrated oil cooling module 10 could include any combination of the drive-cooling components 18, 20 and/or the further drive-cooling components 22, 52, 54, 56 and/or the battery temperature control components 24, 26, 30, 32 and/or the passenger compartment temperature control components 34, 36. Furthermore, the pre-integrated oil cooling module 10 could include additional drive-cooling components and/or additional battery temperature control components and/or additional passenger compartment temperature control components. It is even conceivable that the pre-integrated oil cooling module 10 may include additional cooling systems and/or temperature control systems to be added to the drive-cooling system 12, the battery temperature control system 32, and the passenger compartment temperature control system 38.

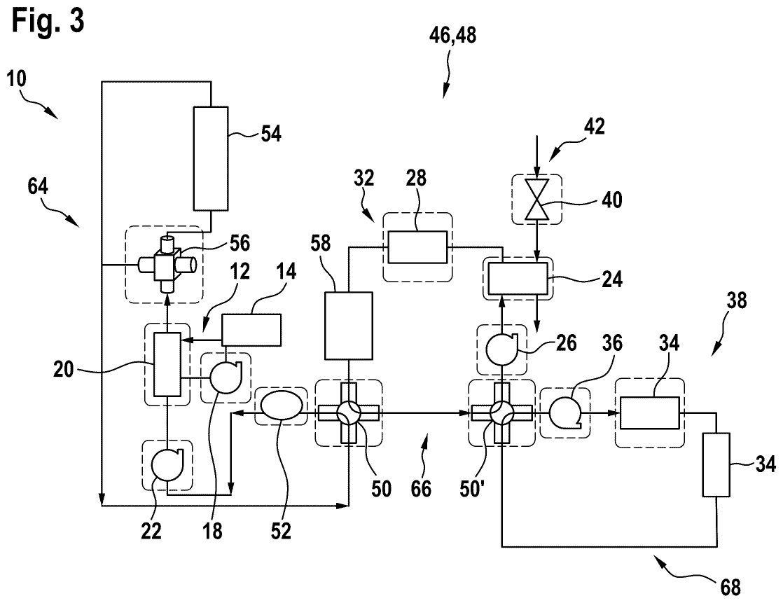

FIG. 3 shows an exemplary block diagram of one of the embodiments 62 of the pre-integrated oil cooling module 10. The embodiment 62 of the pre-integrated oil cooling module shown in FIG. 3 includes the drive-cooling system 12 and the battery temperature control system 32 and the passenger compartment temperature control system 38. One of the further drive-cooling components 22 is designed as a different coolant pump of the drive-cooling system 12, which is different than the oil pump. The coolant pump is designed as an electrically driven coolant pump. The coolant pump is designed to be automatically controllable. The coolant pump provides a volume of coolant flow. One of the further drive-cooling components 52 is designed as a coolant tank. The coolant tank comprises a chamber. Alternatively, the coolant tank could comprise a plurality of chambers. Alternatively, the coolant tank could comprise a chamber for each cooling circuit. The coolant tank is provided to receive excess coolant from a drive-cooling circuit of the drive-cooling system 12. The coolant tank is provided to supply coolant for the drive-cooling circuit. The coolant tank is configured as a type of buffer for the drive-cooling system 12. One of the further drive-cooling components 54 is designed as a coolant radiator. The coolant radiator is configured to dissipate heat from the coolant. It is also conceivable that the pre-integrated oil cooling module 10 may be designed without a tank. For example, the active components may be collected into a manifold 44 of the pre-integrated oil cooling module 10. The coolant radiator is designed as a cooler. The cooler is designed as an air cooler. Alternatively, the radiator could also be configured as a heat exchanger, which transfers the heat from the coolant to a further transfer medium. One of the further drive-cooling components 56 is designed as a bypass valve. The bypass valve is configured to selectively turn the coolant radiator on and off. For example, the coolant radiator could be engaged when the drive is running at full load and temporarily requires additional cooling.

One of the battery temperature control components 26 is designed as a coolant pump of the battery temperature control system 32. The coolant pump is designed as an electrically driven coolant pump. The coolant pump is designed to be automatically controllable. The coolant pump provides a volume of coolant flow. The coolant pump of the battery temperature control system 32 is identical in design to the coolant pump of the drive-cooling system 12. The coolant pump of the battery temperature control system 32 is configured for recirculation of a coolant of a battery temperature control circuit of the battery temperature control system 32. One of the battery temperature control components 28 is designed as a drive battery heating element. The drive battery heating element is configured to heat the drive battery. For example, the drive battery heating element could heat a drive battery 58 and/or other batteries upon a start of the vehicle 16 and/or at low temperatures. The drive battery heating element is designed as a heating element with a positive temperature coefficient (PTC heating element). The drive battery heating element could also be configured as a comparable electric heating element, for example a heating wire. One of the battery temperature control components 24 is designed as a coolant heat exchanger. The coolant heat exchanger is designed to dissipate heat generated by the drive battery 58 of the vehicle 16. The pre-integrated oil cooling module 10 comprises a cooling circuit component 40 of a separate cooling circuit 42. The cooling circuit component 40 is designed as a coolant expansion valve of the separate cooling circuit 42. The coolant expansion valve is configured to control a temperature of a coolant of the cooling circuit 42. The coolant heat exchanger of the battery temperature control system 38 is configured to transfer the heat from a coolant of a battery temperature control circuit from the battery temperature control system 38 to the coolant of the cooling circuit 42.

One of the passenger compartment temperature control components 34 is designed as a passenger compartment heating element. The passenger compartment heating element is designed as a positive temperature coefficient (PTC) heating element. The passenger compartment heating element could also be configured as a comparable electric heating element, for example a heating wire. The passenger compartment heating element is identical in design to the drive battery heating element. One of the passenger compartment temperature control components 36 is designed as a coolant pump of the passenger compartment temperature control system 38. The coolant pump is designed as an electrically driven coolant pump. The coolant pump is designed to be automatically controllable. The coolant pump provides a volume of coolant flow. The coolant pump of the passenger compartment temperature control system 38 is identical in design to the coolant pump of the drive-cooling system 12. The coolant pump of the passenger compartment temperature control system 38 is adapted for recirculation of a coolant of a passenger compartment temperature control circuit 68 of the passenger compartment temperature control system 38. One of the passenger compartment temperature control components 60 is designed as a passenger compartment heat exchanger. The passenger compartment heat exchanger is provided to radiate the heat of the coolant of the passenger compartment temperature control system 38 into the air of the passenger compartment.

The pre-integrated oil cooling module 10 has two connecting valves 50, 50′. The connecting valve 50, 50′ is configured as a 3-way valve. The connecting valve 50 is provided to fluidly connect a drive-cooling circuit 64 of the drive-cooling system 12 to a battery temperature control circuit 66 of a battery temperature control system 32. The connecting valve 50′ is provided to fluidly connect the battery temperature control circuit 66 to the passenger compartment temperature control circuit 68. The connecting valve 50, 50′ is configured to selectively and automatically connect or disconnect two or three coolant circuits. For example, the connecting valve 50 may be used to connect and/or disconnect the drive-cooling circuit 64 to/from the battery temperature control circuit 66 and/or the passenger compartment temperature control circuit 68. Alternatively, the pre-integrated oil cooling module 10 could also have only one connecting valve 50, which is configured as a 5/2-way valve. The 5/2-way valve could be configured to selectively automatically connect and disconnect the circuits from the drive system and the battery temperature control system and the passenger compartment temperature control system. The connecting valve 50, 50′ is configured to operate in series or in parallel with the three circuits. For example, each of the three circuits may be self-contained and/or independently operable. For example, two of the three circuits may be connected in series. For example, all three circuits may be connected in series. The connecting valve is electrically controllable.

The pre-integrated oil cooling module 10 comprises a manifold 44. The manifold 44 includes a conduit of a drive-cooling circuit 64. The manifold 44 includes a conduit of the battery temperature control circuit 66. The manifold 44 includes a conduit of the passenger compartment temperature control circuit 68. The manifold 44 could also have multiple conduits and/or tubes and/or channels. The manifold 44 partially forms a housing from the pre-integrated oil cooling module 10. The use of a single housing eliminates the need for an additional mechanical and hydraulic interface. For example, the number of coolant connections for the conventional approach comprising only individual components may be reduced by using one of the embodiments 62 from 31 from 25 to 7 (see FIG. 2). For example, fewer auxiliary elements, such as holders, clips and gaskets, are needed, thereby reducing the risk of leakage.

The pre-integrated oil cooling module 10 comprises a sensor 46. The sensor 46 is configured to sense a temperature and/or pressure of one of the drive-cooling components 18, 20, 22, 52, 54, 56, and one of the battery temperature control components 24, 26, 28, 30, and one of the passenger compartment temperature control components 34, 36. It is also conceivable that the sensor will sense pressure and/or temperature only on individual components. The sensor senses the temperature and/or pressure within the conduit of drive-cooling circuit 64 and battery temperature control circuit 66 and the passenger compartment temperature control circuit 68. The sensor could also be configured to sense moisture and/or a glycol content of the coolant and/or a flow quantity and/or a parameter that is useful to a person skilled in the art.

The pre-integrated oil cooling module 10 comprises a central power and data transfer interface 48. The power and data transfer interface 48 is configured to provide electrical power and/or a data link to a module-integrated drive-cooling component 18, 20, 22, 52, 54, 56 and a module-integrated battery temperature control component 24, 26, 28, 30 and a module-integrated passenger compartment temperature control component 34, 36 and the module-integrated connecting valve 50 and the module-integrated sensor 46. The data interface 48 is configured to communicate with the controller from the vehicle 16. The power interface 48 is configured to connect to the drive battery. The power and data interface 48 is integrated to be cooled by the coolant from the drive-cooling circuit 64 and/or the battery temperature control circuit 66 and/or the passenger compartment temperature control circuit 68.

1. A pre-integrated oil cooling module for a drive-cooling system that is configured to cool a drive unit of a vehicle using oil as a heat transfer medium, the pre-integrated oil cooling module comprising:
at least one drive-cooling component, which includes at least one of (i) an oil pump configured to recirculate the heat transfer medium, and (ii) an oil heat exchanger configured to dissipate heat absorbed by the drive unit via the heat transfer medium; and
at least one of (i) at least one further drive-cooling component of the drive-cooling system, (ii) at least one battery temperature control component of a battery temperature control system of the vehicle, and (iii) at least one passenger compartment temperature control component of a passenger compartment temperature control system of the vehicle.

2. The pre-integrated oil cooling module according to claim 1, wherein:
the at least one drive-cooling component and the at least one further drive-cooling component comprises at least three drive-cooling components of the drive-cooling system; and/or
the at least one battery temperature control component comprises at least two battery temperature control components of the battery temperature control system of the vehicle; and/or
the at least one passenger compartment temperature control component comprises at least two passenger compartment temperature control components of the passenger compartment temperature control system of the vehicle.

3. The pre-integrated oil cooling module according to claim 1, wherein the further drive-cooling component includes a coolant pump of the drive-cooling system different from the oil pump, a coolant tank, a coolant radiator, or a bypass valve configured to selectively turn on and off the coolant radiator.

4. The pre-integrated oil cooling module according to claim 1, wherein the battery temperature control components include a coolant heat exchanger for dissipating heat generated by a drive battery of the vehicle, a coolant pump of the battery temperature control system, or a drive battery heating element.

5. The pre-integrated oil cooling module according to claim 1, wherein the passenger compartment temperature control components include a passenger compartment heating element or a coolant pump of the passenger compartment temperature control system.

6. The pre-integrated oil cooling module according to claim 1, further comprising at least one cooling circuit component of a separate cooling circuit.

7. The pre-integrated oil cooling module according to claim 1, further comprising at least one connecting valve configured to selectively connect or disconnect at least two coolant circuits of the drive-cooling system, the battery temperature control system, and/or the passenger compartment temperature control system.

8. The pre-integrated oil cooling module according to claim 1, further comprising a manifold including at least one conduit of at least one of (i) a drive-cooling circuit of the drive-cooling system, (ii) a battery temperature control circuit of the battery temperature control system, and (iii) a passenger compartment temperature control circuit of the passenger compartment temperature control system.

9. The pre-integrated oil cooling module according to claim 1, further comprising at least one sensor configured to sense at least one of a temperature and a pressure of one or more of: (i) the at least one drive-cooling component, (ii) the at least one further drive-cooling component, (iii) the at least one battery temperature control component (iv) the at least one passenger compartment temperature control component, and (v) conduit of a cooling circuit.

10. The pre-integrated oil cooling module according to claim 1, further comprising a central power and/or data transfer interface, which is configured to supply electrical power and/or a data link to at least one of (i) at least one module-integrated drive-cooling component, (ii) at least one module integrated battery temperature control component, (iii) at least one module-integrated passenger compartment temperature control component, (iv) at least one module-integrated connecting valve that is configured to selectively connect or disconnect at least two coolant circuits, and (v) at least one module-integrated sensor.

11. A vehicle comprising:
the pre-integrated oil cooling module according to claim 1.

12. The pre-integrated oil cooling module according to claim 1, wherein the pre-integrated oil cooling module is configured for the drive-cooling system of an electric drive unit (EDU) of a battery and/or fuel-cell operated vehicle.

13. The pre-integrated oil cooling module according to claim 6, wherein the at least one cooling circuit component is a cooling agent expansion valve of the separate cooling circuit.

14. The vehicle according to claim 11, wherein the vehicle is a battery and/or fuel-cell operated vehicle.
